(19) United States
(12) Patent Application Publication
(10) Pub. No.: US 2019/0310888 A1
(43) Pub. Date: Oct. 10, 2019

(54) Allocating Resources in Response to Estimated Completion Times for Requests

(71) Applicant: The Fin Exploration Company, San Francisco, CA (US)

(72) Inventors: Samuel Lessin, San Francisco, CA (US); John Graham, San Francisco, CA (US); Andrew Kortina, San Francisco, CA (US); Michael Cohen, San Francisco, CA (US)

(21) Appl. No.: 16/172,679

(22) Filed: Oct. 26, 2018

Related U.S. Application Data
(60) Provisional application No. 62/653,415, filed on Apr. 5, 2018.

(51) Int. Cl. G06F 9/50; G06F 11/34; G06F 15/18; G06N 5/04; G06F 17/27

(52) U.S. Cl. CPC G06F 9/505; G06F 9/5044; G06F 17/277; G06F 15/18; G06N 5/046; G06F 11/3442

(57) ABSTRACT

Methods, and systems for processing a request sent to a virtual assistant management system and for allocating resources, e.g., computing resources, in response to such requests. One of the methods includes: receiving a request; determining a category of the request; determining actions associated with completing the request; using a machine learning model to estimate an amount of time to complete the request based on the category and the actions associated with completing the request, wherein the machine learning model was trained using features characterizing a previous request that was completed by an agent and the time it took the agent to complete the previous request; and rating an agent's performance based in part on a comparison of an amount of time it takes an agent to complete the request and the estimated amount of time to complete the request generated by the machine learning model.

### CROSS-REFERENCE TO RELATED APPLICATIONS

This application claims the benefit under 35 U.S.C. § 119(e) of the filing date of U.S. Patent Application No. 62/653,415, for Allocating Resources in Response to Estimated Completion Times for Requests, which was filed on Apr. 5, 2018 and which is incorporated here by reference.

### FIELD

This specification relates to processing a request sent to a management system, such as a virtual assistant management system, and to allocating resources, such as computing resources, in response to such requests.

### BACKGROUND

Systems that manage virtual personal assistants can employ both computer and human agents to perform a request sent to the system by a user. The time an agent takes to perform a request can vary according to a number of factors. For example, the time can vary due to the number of agents that worked on the request, the efficiency of the agent(s) performing the request, and the complexity of the request. As a result of these factors, similar requests can take different amounts of time. Because these factors are largely out of the user's control, the user can become dissatisfied with inconsistent response times of the system.

### SUMMARY

This specification describes technologies for processing a request sent to a management system, such as a virtual assistant management system, and to allocating resources, such as computing resources, in response to such requests. These technologies generally involve estimating the time it takes one or more human agents (e.g., using conventional techniques) to complete a request having a set of specified features.

In general, one innovative aspect of the subject matter described in this specification can be embodied in methods that include the actions of: a) obtaining training data for training a machine learning model, wherein the training data comprises features characterizing a request that was completed by at least one agent and the time it took the at least one agent to complete the request and wherein the machine learning model is configured to generate as output an estimated time that it will take an agent to complete a new request; b) training the machine learning model on the training data to generate a trained machine learning model; c) receiving features of a new request; and d) processing the features of the new request using the trained machine learning model to generate as output an estimate of the amount of time that it will take an agent to complete the new request.

Training the machine learning model can include: receiving for each of a plurality of requests a measure of successful completion; and training the machine learning model on training data that includes only requests completed with a measure of successful completion that is greater than or equal to a threshold value.

The method can further include allocating resources to complete the new request based on the estimate of the amount of time that it will take an agent to complete the new request.

Another innovative aspect of the subject matter described in this specification can be embodied in methods that include the actions of: receiving a request; determining a category of the request; determining actions associated with completing the request; using a machine learning model to estimate an amount of time to complete the request based on the category and the actions associated with completing the request, wherein the machine learning model was trained using features characterizing a previous request that was completed by at least one agent and the time it took the at least one agent to complete the previous request; and rating an agent's performance based in part on a comparison of an amount of time it takes an agent to complete the request and the estimated amount of time to complete the request generated by the machine learning model.

Obtaining a category can include: receiving text corresponding to the request; identifying one or more keywords of the text; and determining the category of the request based, at least in part, on the one or more keywords.

Obtaining actions associated with completing the request can include: receiving text corresponding to the request; identifying one or more keywords of the text; and determining the actions associated with completing the request based, at least in part, on the one or more keywords.

The method can further include obtaining a tag for the request from a profile of preferences of a user, wherein the preferences of the user are determined from actions associated with completing one or more previous requests.

The machine learning model can estimate the time to complete the request based at least in part on a request category, the actions associated with completing the request, and a request tag.

The request that is completed by the at least one agent can be assigned to the at least one agent based at least in part on features characterizing the request.

Still another innovative aspect of the subject matter described in this specification can be embodied in methods that include the actions of: receiving a request; obtaining a first tag for the request; receiving, from an agent, a second tag for the request; and using a machine learning model to estimate a time to complete the request based on the first tag and the second tag, wherein the machine learning model was trained using features characterizing a previous request that was completed by at least one agent and the time it took the at least one agent to complete the previous request.

Yet another innovative aspect of the subject matter described in this specification can be embodied in methods that includes one or more computers and one or more storage devices on which are stored instructions that are operable, when executed by the one or more computers, to cause the one or more computers to perform operations including: receiving a request; determining a category of the request; determining actions associated with completing the request; using a machine learning model to estimate an amount of time to complete the request based on the category and the actions associated with completing the request, wherein the machine learning model was trained using features characterizing a previous request that was completed by at least one agent and a time it took the at least one agent to complete the previous request; and rating an agent's performance based in part on a comparison of the amount of time it takes an agent to complete the request and the estimated amount of time to complete the request generated by the machine learning model.

Obtaining a category can include: receiving text corresponding to the request; identifying one or more keywords of the text; and determining the category of the request based, at least in part, on the one or more keywords.

Obtaining actions associated with completing the request can include: receiving text corresponding to the request; identifying one or more keywords of the text; and determining the actions associated with completing the request based, at least in part, on the one or more keywords.

The operations can further include obtaining a tag for the request from a profile of preferences of a user, wherein the preferences of the user is determined from actions associated with completing one or more previous requests.

The machine learning model can estimate the time to complete the request based on a category of the request, the actions associated with completing the request, and a tag of the request.

The request that is completed by the at least one agent can be assigned to the at least one agent based at least in part on features characterizing the request.

The subject matter described in this specification can be implemented in particular embodiments so as to realize one or more of the following advantages.

A virtual personal assistant system can use an estimated amount of time it will take one or more agents of the system to complete a request, to allocate the system's resources. For example, the system can use historical data to predict the volume and category of requests for a certain time period. For a corresponding future time period, the system can use the machine learning model to estimate the amount of time it will take one or more agents to complete requests received during the time period. The virtual personal assistant system can then determine the number of resources to be active during the time period, such as the number of servers to run or the number of phone or computer stations to activate.

Another advantage, provided in part by the machine learning model, is that the virtual personal assistant system can use the estimated time to estimate a value associated with a request. For example, the virtual personal assistant system can provide a user an estimation of how much time or resources a request will typically take to complete, therefore setting expectations for a user.

The virtual personal assistant system can measure an agent's performance based at least in part on the time it takes the agent to complete a request (or a task that is necessary to complete the request) having a particular set of features as compared to an estimated completion time for a similar request (or task), e.g, for a request that has that particular set of features or a similar set of features. Measuring an agent's performance allows the virtual personal assistant system to assign requests to an agent based on an agent's particular skills, therefore increasing the efficiency of completing requests.

Yet another advantage of systems and methods described in this specification is that they enable determination of how long an action taken by a computer would take a human being.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of one example of a virtual personal assistant system.

FIG. 2 is a flowchart for an exemplary method of generating an estimated amount of time that an agent will take to complete a request.

FIG. 3 is a flowchart for an exemplary method of rating an agent's performance using an estimated amount of time that the agent will take to complete a request.

FIG. 4 is another illustration of generation of a time estimate for completion of a request,

FIG. 5 is another illustration of the training of the machine-learning model.

Like reference numbers and designations in the various drawings indicate like elements.

### DETAILED DESCRIPTION

A virtual personal assistant system can receive a request, which represents one or more tasks that a user wants the system to perform. The request is completed when one or more agents of the system perform the one or more tasks associated with the request. The one or more agents of the system can be computer agents, human agents, or a combination of computer and human agents.

The system can assign one or more categories to the request. A prediction model can create predictions for categories and in one implementation a human agent can modify the predicted category(ies). The system receives data regarding prior inbound messages and the agent-labeled categories and tags. The system uses that data to build a prediction model to apply to new inbound messages so as to predict a category and tags. Agents can then accept/reject the suggestions, and accepted suggestions feed future training.

A category can specify the type of request or task the system needs an agent to complete. For example, the categories can include scheduling (e.g., scheduling a restaurant reservation), shopping (e.g., buying an item from an online retailer), and researching (e.g.performing research using one or more online search engines). Agents of the system can also assign one or more categories to a request.

From a nomenclature perspective, this specification refers to message_threads as the vehicles where messages are contained. The system extracts requests from messages. A category can apply to both a message_thread and a request.

The system can also assign one or more tags to the request. As with categories, a prediction model can create the predictions for tags and in one implementation a human agent can modify the predicted category(ies). The one or more tags can further distinguish the requests in a shared category. For example, a tag could specify the meal (e.g., breakfast, lunch, dinner, etc.) for which the agent wants a restaurant reservation. As another example, a tag can provide information specific to the user, such as the user's preferred online retailers for requests in the shopping category. Just as agents of the system can assign one or more categories to the request, the agents can also assign one or more tags to the request.

The virtual personal assistant system can store the categorized and tagged requests in a database. The system can search the database according to attributes of the requests including the categories and tags associated with a request, the date that the request was received, and the time it took one or more agents to complete a request.

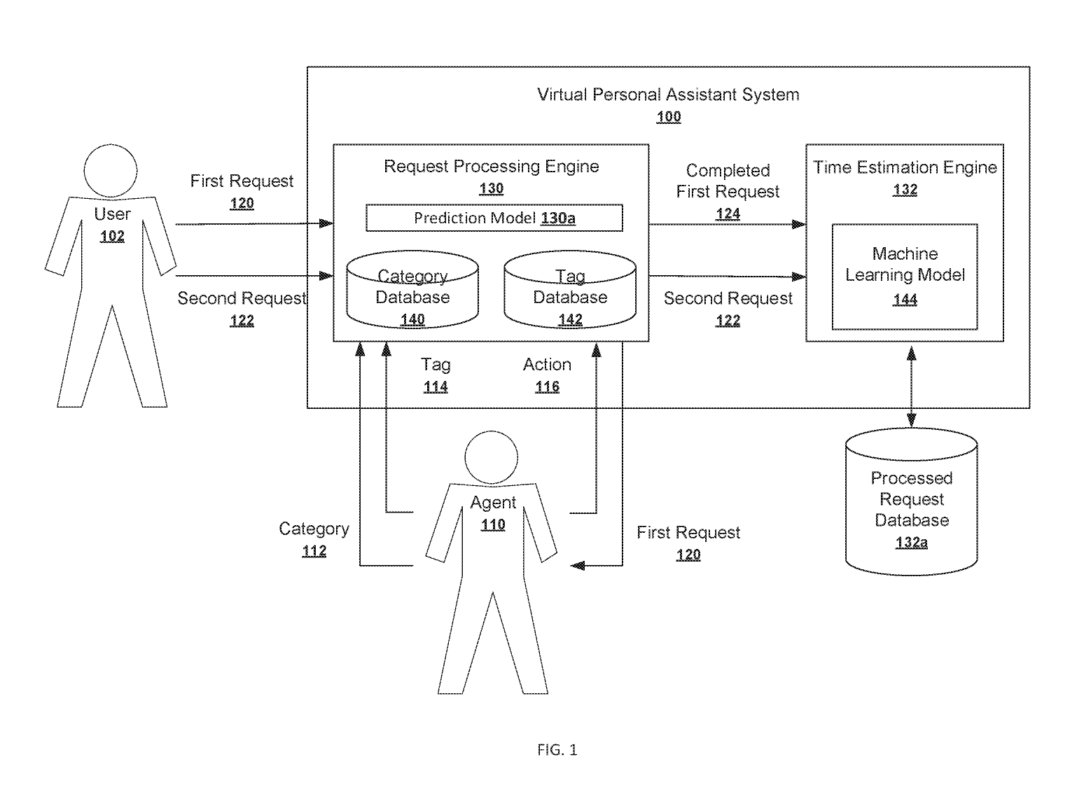

FIG. 1 is a block diagram of one example of a virtual personal assistant system 100. FIG. 1 shows a user 102 that can send requests, such as a first request 120 and a second request 122, to the virtual personal assistant system 100. The first and second requests 120 and 122 each correspond to separate tasks that a user of the virtual personal assistant system 100 wants completed by the system. For example, a request could be “Please make a reservation for two at 730 pm tonight at my favorite restaurant”

The system 100 can associate a request with features. Features of a request can include a category and/or a tag that corresponds to the type of task the user wants completed. Features of a request can also include information related to the completion of the request by the virtual personal assistant system 100. A request processing engine 130 of the virtual personal assistant system 100 can receive the first and second requests 120 and 122 and process the requests by adding certain features such as a category, a tag, or both to the requests. A prediction model 130a can create the predictions for at least one category and tag and in one implementation a human agent can modify the predicted category(ies) and/or tag(s).

The request processing engine 130 can include a category database 140. The request processing engine 130 can query the category database 140 to retrieve a category from the database. The request processing engine 130 can also include a tag database 142. The request processing engine 130 can query the tag database 140 to retrieve a tag from the database. The request processing engine 130 can apply one or more tags to a request to further distinguish it from other requests within a shared category. For example, the requests “Book me a reservation tonight at a restaurant near me” and “Move my dental appointment to 1 PM on Monday” both relate to scheduling; therefore, the request processing engine 130 can assign the requests the scheduling category. The request processing engine 130 can further distinguish between the two requests by assigning the tag “restaurant reservation” to the former request and “medical appointment” to the latter request.

As another example, the request processing engine 130 can process a request to include data that reflects the time that the request was received. The request processing engine 130 can use the data to determine one or more tags for the request. For example, for a request related to making a restaurant reservation that was sent to the virtual personal assistant system 100 in the evening, the request processing engine 130 can determine that the user who sent the request likely wants a dinner reservation rather than a breakfast or lunch reservation. In response to that determination, the request processing engine 130 can add the tag “dinner” to the request.

An agent of the virtual personal assistant system 100 can also add both a category and a tag to a request received by the request processing engine 130. For example, an agent 110 can view a request received by the request processing engine 130 and determine the type of task to which the request corresponds. The agent 110 can then label the task with a category 112 and/or a tag 114, and the request processing engine 130 can store the task-category and task-tag associations. In addition, an agent can provide a category and/or a tag for a request n. Not only can an agent add a category and a tag to a request, an agent can also remove a category or tag that is incongruous with a request and assign the request a new category or tag that is more appropriate for the request.

The request processing engine 130 can process the first request 120 and second request 122, as described above. The request processing engine 130 can allow an agent 110 to work on the first request 120. For example, the request processing engine 130 can allow an agent 110 to access the first request 120.

The agent 110 can work on one or more tasks that correspond to the first request 120. For example, in response to the request “Book me a reservation for two tonight at a restaurant near me”, the agent 110 can determine the location of the user that sent the request, determine which restaurants are near the user's location, and call one of the nearby restaurants to make a reservation. The actions that the agent 110 performs to complete the first request 120 can be recorded by the request processing engine 130. The request processing engine 130 can add additional features identifying the actions taken to complete the first request 120. The request and its associated data (including associated features and time to completion) form a completed first request 124.

As previously mentioned, a completed request can include a category feature and a tag feature. A number of other examplary features that the request processing engine 130 can add to the first request 120 are described below.

The features can further include a num_entry_tag_created feature, which can correspond to the number of tags associated with a particular request.

A request can also include a lock_session_id feature. The lock_session_id feature can be a numerical value that the virtual personal assistant system 100 can use to identify the request.

Other features of a request can include an intercept feature. The intercept is a standard feature to have in a regression. It can be thought of as the time necessary for an agent to process a request regardless of any other input.

A request can further include a num_locks feature. A lock can correspond to a task that an agent receives exclusive access to work on. That is, an agent can lock a task of a request in order to work on that task and to prevent other agents from working on the task. The num_locks feature can be a numerical value that corresponds to the number of tasks that one or more agents locked during the time the request was completed.

The features can also include a num_phonecalls feature. This feature can be a numerical value that corresponds to the number of calls one or more agents placed while completing the request. The request processing engine can also associate a completed request with a phonecall_minutes feature, which can be a numerical value that corresponds to the collective duration in minutes of all calls placed while completing the request.

A request can further include an is_email_thread feature, and a num_entry_viewed feature. The is_email_thread feature is a boolean indicator regarding whether or not the message_thread is communicated via an email medium or through another one of our channels (e.g., iOS-app, web-app, etc.). Information in the system's information graph is stored as entries. The num_entry_viewed feature is an integer count of the number of internal information graph entries an agent viewed while working on a request in order to complete a task.

In addition, the features can include a num_message_sent feature that includes the num_user_messages and the num_agent_messages. The num_user_messages corresponds to an integer count of the number of messages sent by each party during the course of the fulfillment of a particular request in question. A completed request can further include a num_chars_in_user_messages feature, which can be a numerical value that corresponds to the number of characters of a message that the virtual personal assistant system 100 received from a user. Similar to the num_user_messages and num_chars_in_user_messages features, the request processing engine 130 can also associate a request with a num_agent_messages feature and a num_chars_in_agent_messages feature. The num_agent_messages feature refers to messages sent by an agent during the course of the fulfillment of a particular request in question. num_chars_in_agent_messages is the number of characters in aggregate across all of those particular messages.

Additional features can include a num_message_thread_notes_edited feature and a num_message_thread_checklist_item_archived feature. These features are notes that an agent might take during the course of work on a particular request. The idea of capturing this information is that capturing such notes could take up time that the system can take into account when deriving an estimate of how long a request or task should take.

Additional features can include a num_request_entry_created feature. Request entries are units of work. The system captures, during the course of a locked session, how many integer request entries are created. A locked session is a session in which only one agent is working on a thread (and a thread is set of interactions related to at least one request from a user). When there is an entry type that is specialized enough, the system captures it as a unique action that has a certain amount of time associated with it.

Additional features can include a num_other_entry_created feature. The num_other_entry_created feature captures the remainder of entries created during the course of a working session that aren't specifically mentioned by another entry feature. The idea here is that entry creation takes a certain amount of time, and we want to capture that in coming up with a best estimate of the time it should take a human agent to respond to a request.

The request processing engine can also assign a num_external_url_visited feature to a request that can be a numerical value that corresponds to the number of URLs of a domain that is not associated with that of the virtual personal assistant system 100.

In addition, the features can include a num_calendar_entries_created feature. This feature can be a numerical value that corresponds to the number of calendar entries created by an agent for a user of the virtual personal assistant system 100.

Another feature of a request can be a num_triggerable_entry_created feature, a num_triggerable_recipients feature, and a num_char_in_triggerable_message feature. A triggerable entry refers a type of work that an agent will perform during the course of a working session that will trigger at some point in the future. These features capture the amount of time it takes to create these future events in coming up with a best estimate.

There is some variability in these triggered events or events that will occur in the future. Thus the system captures that variance in complexity, e.g., via the number of recipients for the triggered message as well as the characters in the triggered message.

The features can further include a num_entry_attribute_created feature; a num_dashboard_search_executed feature; and a num_checklist_item_marked_done. Dashboard searches can take place during the course of working on a request and when an agent is searching the system's information graph for information. The system captures the approximate time for such searching by recording the number of searches executed. Checklists are both human and machine generated. The system captures how many items on such checklists are marked done during the course of a working session. The type and number of checked items serve as a proxy for work that is accomplished and how much time it took to accomplish that work.

In addition to the previously-mentioned features, a completed request can also include data related to the amount of time it took one or more agents to complete the request. For example, the completed first request 124 can include data related to the amount of time it took agent 110 to complete the request by performing action 116.

The system 100, e.g., the time estimation engine 132, includes a machine learning model 144. A time estimation engine 132 can receive requests and use the requests to train the machine learning model 144 used by the time estimation engine 132. The machine learning model 144 can use the features of the request to generate an estimated completion time that corresponds to an amount of time it will take one or more agents to complete the request. The machine learning model 144 can maintain a coefficient for each feature and, using these coefficients, give a higher weight to certain features when generating the estimated completion time for a particular request. Training the machine learning model 144 includes determining the coefficient for each of the features to generate the estimated completion time.

The time estimation model 132 can use completed requests to train the machine learning model 144. For example, after the agent 110 completes the first request 120, the request processing engine 130 can add data corresponding to the completion of the first request 120 to form the completed first request 124. The data that the processing engine 130 adds to the first request 120 can include the previously mentioned features and the amount of time that agent 110 spent completing the request. The request processing engine 130 can then send the completed first request 124 to the time estimation engine 132 to use in training the machine learning model 144.

An authorized agent or an administrator can take the estimate of the time estimation engine and modify the estimate. The modified estimate gets stored in the processed request database 144.

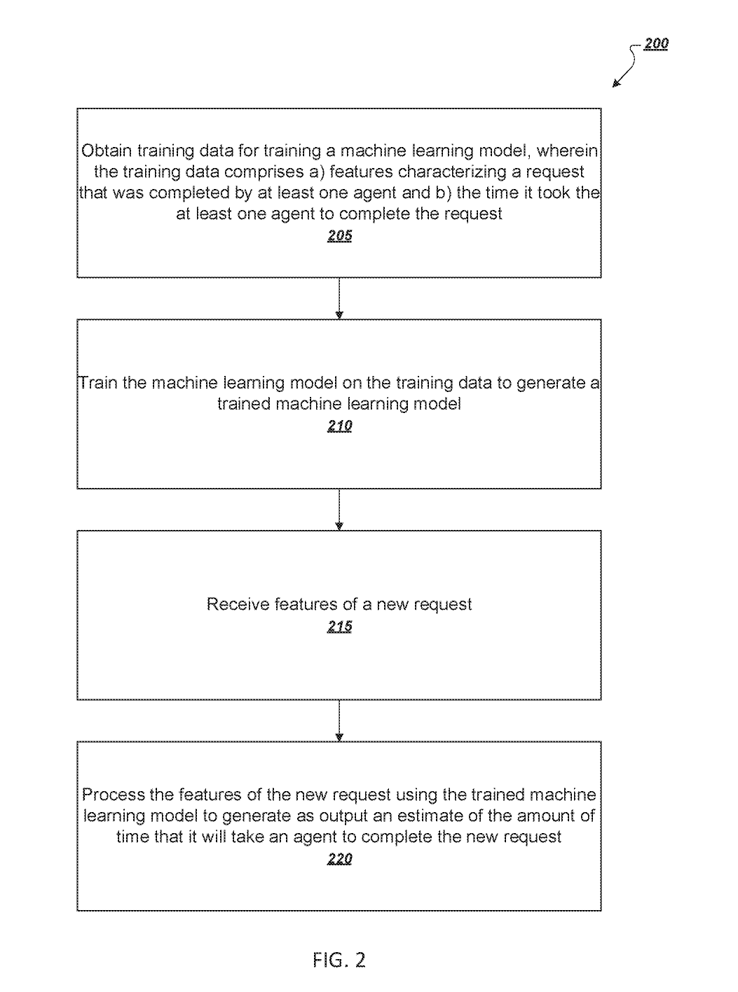

FIG. 2 is a flowchart 200 for an exemplary method of generating an estimated amount of time that an agent will take to complete a request. When appropriately configured, a virtual personal assistant system, such as the virtual personal assistant system 100, can perform the example method.

With reference to FIGS. 1 and 2, the virtual personal assistant system determines training data for training a machine learning model, wherein the training data comprises features characterizing a request that was completed by at least one agent and the time it took the at least one agent to complete the request and wherein the machine learning model is configured to generate as output an estimated time that it will take an agent to complete a new request (205). The training data can include data associated with a completed request, such as features of the request, e.g., at least one of a category and a tag, as well as one or more actions performed by one or more agents to complete the request. The actions and the associated time for completion of the actions can be stored in an actions database (not shown).

The training data can also include the amount of time that it took the one or more agents to complete the request. For example, a request processing engine 130 can receive the one or more actions and determine the amount of time that one or more agents spent completing the one or more actions. The request processing engine 130 can also determine the overall time to complete the request, e.g., if the request involves multiple tasks and associated actions. The request processing engine 130 can receive the features, actions, and completion time associated with the request and use this information to generate completed request data that can be used to train the machine learning model.

The virtual personal assistant system trains the machine learning model on the training data to generate a trained machine learning model (210). A time estimation engine can receive the completed request that includes the training data. In one implementation, the time estimation engine can include a machine learning model that uses regression analysis to generate the estimated completion time. For example, the time estimation engine 132 can prepare the training data to be used as input to a linear regression model. The time estimation engine 132 can prepare the training data in different ways. For example, the time estimation engine 132 can calculate the logarithm of each feature having a numerical value (other than the lock_session_ID) to generate a log-transformed value for each of the features. The machine learning model can represent features that do not have inherent numerical values, such as categories or tags, as categorical variables in the regression. The machine learning model can then multiply each log-transformed value and categorical variable by a coefficient in a set of coefficient values. The machine learning model can then generate a multiple linear regression model by summing each coefficient/feature product.

The time estimation engine can use the multiple linear regression model to generate an output value that represents the log of an estimated amount of time it should have taken an agent to complete the completed request. The time estimation engine can transform the output into an amount of time by taking the inverse log of the output value. The machine learning model can also generate a prediction interval for the generated output. For example, the prediction interval can be set to apply to a specified percentage of the training date, e.g., 75%, 80%, or 85%. In addition, the machine learning model can also generate an upper bound and lower bound for the generated output.

Training the machine learning model includes determining which set of coefficients allows the machine learning model to generate an estimated time. Because, in one aspect, the machine learning model is trained using completed request data, the amount of time that it took one or more agents to complete the completed request can be used to determine a measure of accuracy for the generated output. For example, the time estimation engine can determine the percent difference or deviation between the time it took an agent to complete the request and the estimated times generated by the machine learning model using alternative sets of coefficients. The time estimation engine can then sort the sets of coefficients in order of the deviation (from the actual completion times) each set produces. The machine learning model can then adopt the set of coefficients that produces the lowest deviation from actual completion times.

In some implementations, each request that the time estimation engine uses to train the machine learning model can be associated with a measure of successful completion. For example, the virtual personal assistant system can determine the measure of successful completion of a request with user feedback that indicates how satisfied the user was following the completion of the request. In these implementations, the virtual personal assistant system can determine a threshold value that corresponds to the lowest measure of successful completion for a request that the system considers to have been successfully completed. The time estimation engine can then train the machine learning model on training data that includes only requests completed with a measure of successful completion that is greater than or equal to the threshold value.

In other implementations, the virtual personal assistant system can allocate resources to complete new requests based on the estimated completion times. For example, the virtual personal assistant system can utilize additional servers only during times of peak demand as determined at least in part by the requests and associated time estimates.

As another example, the virtual personal assistant system can determine the average number of requests per category received during a certain time period of a day. The model can estimate the time that it should take one or more agents to complete a similar profile of requests received during a corresponding time period of a previous day. Using the time estimates, the virtual personal assistant system can determine how many servers receiving requests to operate during the corresponding time period. As another example, the model can recommend an optimal number of active agent computer stations and/or phone stations to be used by agents completing requests during the corresponding time period, and the amount of time that the agent computer stations and/or phone stations should remain active.

The virtual personal assistant system receives features of a new request (215). The virtual personal assistant system processes the features of the new request using the trained machine learning model 144 to generate as output an estimate of the amount of time that it will take at least one agent to complete the new request (220). After the machine learning model 144 has been trained, the time estimation engine 132 can receive a new request, generate a model input from the new request, and use the model input as input to the machine learning model. Using the model input, the machine learning model 144 can estimate an amount of time that it will take an agent to complete the new request.

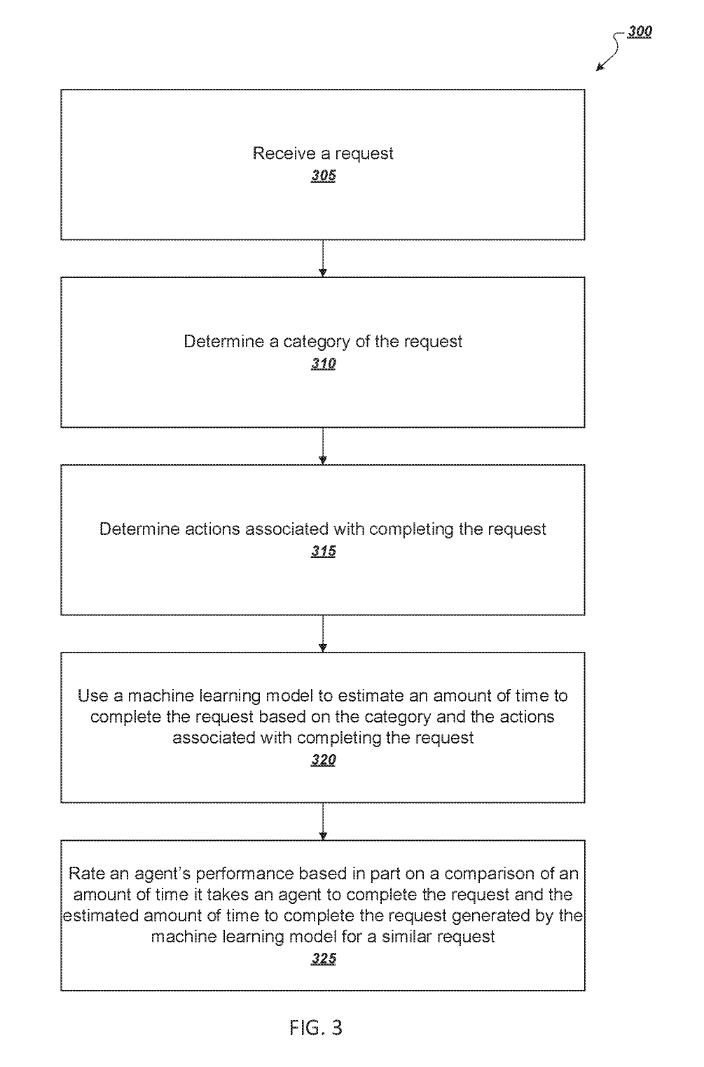

FIG. 3 is a flowchart 300 for an exemplary method of rating an agent's performance using an estimated amount of time that an agent will take to complete a request. When appropriately configured, a virtual personal assistant system, such as the virtual personal assistant system 100, can perform the example method.

With reference to FIGS. 1 and 3, the virtual personal assistant system 100 can receive a request (305) and determine a category of the request (310). In some implementations, the virtual personal assistant system can receive text corresponding to the request and identify one or more keywords of the text. After identifying one or more keywords, the virtual personal assistant system can determine the category of the request based, at least in part, on the one or more keywords. For example, a request could be, “Look up a recipe for Brussels sprouts.” The virtual personal assistant system can identify the keywords “look up”, and determine that the appropriate category of the request is research. In other implementations, the virtual personal assistant system can send the text corresponding to the request to an agent and the agent can determine a category of the request and communicate the category to the virtual personal assistant system.

In other implementations, the virtual personal assistant system can obtain not only a category of the request, but also a tag of the request. For example, the virtual personal assistant system can maintain a profile for a user and the profile can include user preferences. The virtual personal assistant system can determine the user preferences stored in the profile based on one or more previous requests. For example, the virtual personal assistant system can receive from a user the request, “Find me a few pairs of running shoes online.” In response to the request, an agent of the virtual personal assistant system can provide the user with a list of running shoes from a variety of brands and a a variety of online retailers. After receiving the list, the user can choose to buy a pair of shoes on the list that are from a first brand and a first retailer. The virtual personal assistant system can update the user's profile to reflect that the user has a preference for the first brand and the first retailer. Similarly, the agent that provided the list can also update the user's profile. If the virtual personal assistant system receives a similar request from the same user, such as “Show me some casual shoes online”, the virtual personal assistant system can access the user's profile and associate the request with a tag that corresponds to the first brand and the first retailer. An agent working on the similar request can provide the user more options from the first brand and first retailer than a second brand or second retailer, in response to the tag.

The virtual personal assistant system determines actions associated with completing the request (315). In some implementations, the virtual personal assistant system can determine the actions from the category of the request. For example, an action associated with completing a request of the scheduling category can include creating a calendar entry, while an action associated with completing a request of the shopping category can include accessing a user's preferred electronic payment method.

In other implementations, the virtual personal assistant system can determine the actions from the one or more keywords identified from the text corresponding to the request. For example, a request from a user could be, “Buy the items on my grocery list.” The virtual personal assistant system can identify the keywords “grocery list” and determine that an action associated with completing the request includes accessing the user's grocery list. The virtual personal assistant system can also identify the keyword “buy” and determine that another action includes accessing the user's preferred electronic payment method.

Not only can the virtual personal assistant system use one or more keywords to automatically determine the actions, an agent of the system can also determine the actions from the one or more keywords. In this example implementation, the virtual personal assistant system can send the text corresponding to the request to an agent, who can determine one or more actions from the text. The agent can then communicate the one or more actions to the virtual personal assistant system.

The virtual personal assistant system uses a machine learning model to estimate a time to complete the request based on the category and the actions associated with completing the request, wherein the machine learning model was trained using features characterizing a previous request that was completed by at least one agent and the time it took the at least one agent to complete the previous request (320). A time estimation engine of the virtual personal assistant system can train the machine learning model as described above. In this implementation, the time estimation engine can then generate a model input for the request based on the category and the actions associated with completing the request, and use the model input as input to the machine learning model. In other implementations, the time estimation engine can generate a model input for the request based on not only the category and the actions, but also a tag associated with the request. Using the model input, the machine learning model can output an estimated completion time for the request.

The virtual personal assistant system rates an agent's performance based in part on a comparison of an amount of time it takes an agent to complete the request and the estimated amount of time to complete the request generated by the machine learning model (325). For example, let t₁ correspond to the amount of time it takes the agent to complete the request, while t₂ corresponds to the estimated completion time generated by the machine learning model. The virtual personal assistant system can compare the two times in order to rate the agent's performance. For example, the virtual personal assistant system can take the difference between t₂ and t₁ to determine how the agent compares to the estimated amount of time. In this example, a positive difference indicates that the agent completed the request faster than was estimated, while a negative difference indicates that the agent completed the request slower than was estimated. A difference of zero indicates that the completion time was consistent with the estimated completion time. The virtual personal assistant system can record the differences for each completed request and calculate the average to determine a measure of the agent's overall performance. The virtual personal assistant system can also determine a measure of agent performance that is specific to a certain category, i.e., to measure how well an agent performs on requests of the certain category.

In some implementations, the virtual personal assistant system can assign a request to an agent based on the agent's overall performance or the agent's performance with regard to completing requests having a particular feature. For example, the virtual personal assistant system can determine, from a measure of an agent's performance, that the agent works best on a certain category of requests and, in response, prioritize requests of the certain category when assigning requests to the agent.

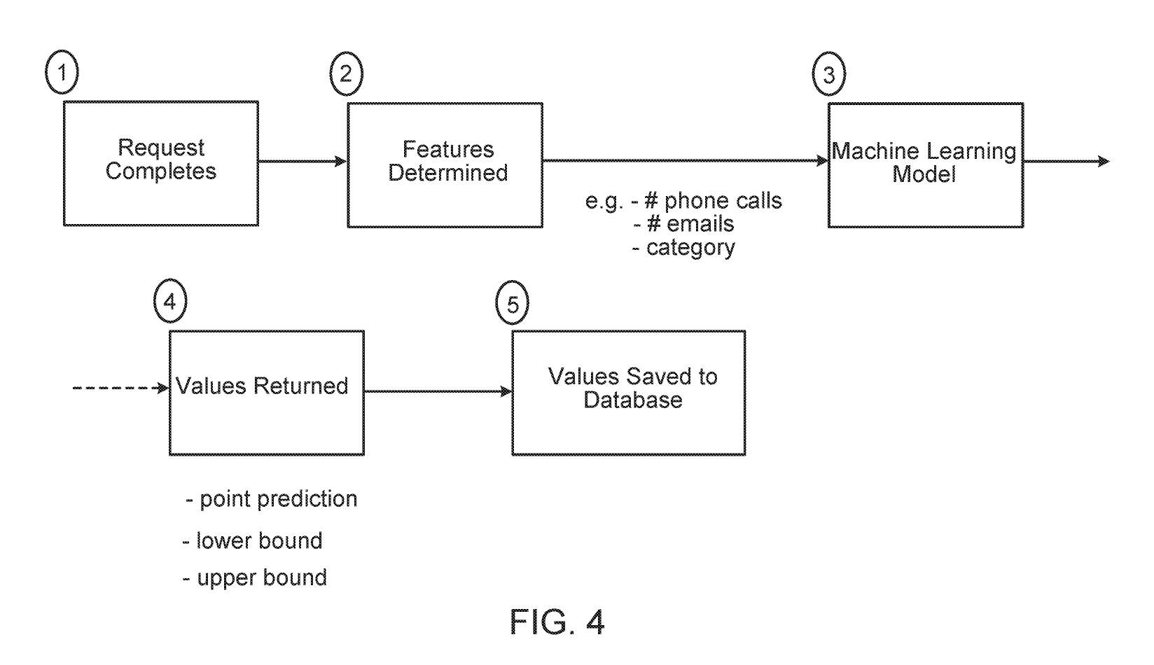

FIG. 4 is another illustration of generation of a time estimate for completion of a request, In step one, a request is completed, e.g., by one or more agents. In step two features of the completed request are associated with the completed request. In step three, the system provides the request features along with other request related data (such as the time for completion of the request) to a machine learning model for estimating the time for completion of a request. In step four, the machine learning model provides time estimates. The time estimates can include a specific prediction as well as a upper and lower bound. In step five, the system saves the time estimates to a database. The steps outlined in FIG. 4 are not necessarily performed in order. For example at least some of the features of a request can be determined prior to a request completing.

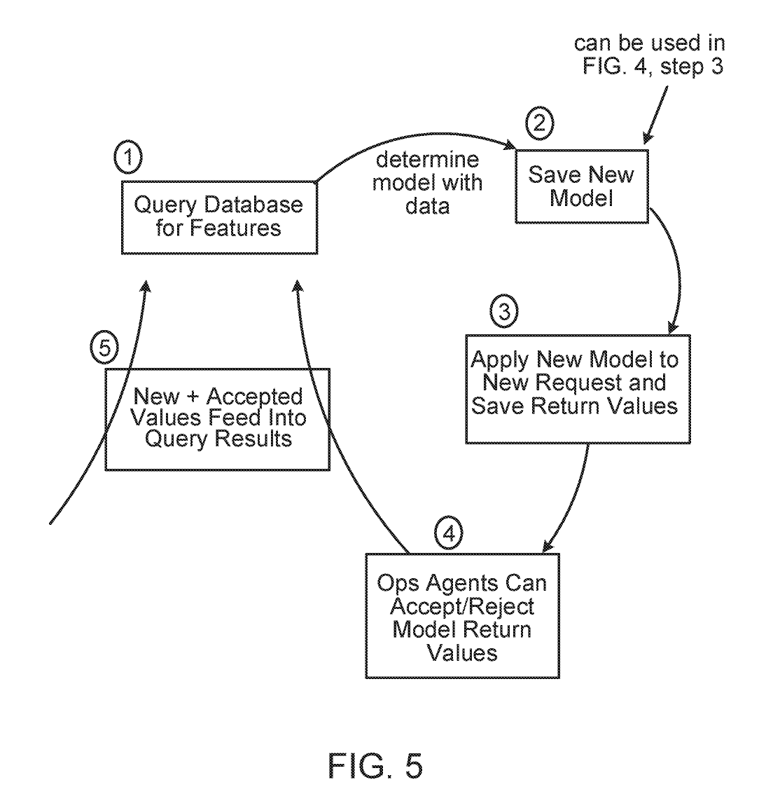

FIG. 5 is another illustration of the training of the machine-learning model. In step one the system queries a processed request database features associated with a set of requests, e.g., completed requests. With reference to FIGS. 1 and 5, the system trains a machine learning model 144 using data including feature data and time of completion data associated with the set of requests used for training the model. In step two the system saves the machine learning model as machine learning model 144. In step three, the system 100 applies the trained machine learning model 144 to new request data to determine a return value, e.g., an estimate of time to completion for the new request. In step four, operations agents can accept or reject the return value. In step five, both new and accepted values are provided to the processed request database to form part of the data provided to retrain the machine learning model 144. The new values can include requests completed during the time that has passed since the last training of the machine learning model. Using the process outlined in FIG. 5, the machine learning model can adapt to changing circumstances and improve its results, e.g., its estimation of time to completion of a new request.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

What is claimed is:

1. A computer implemented method comprising:
obtaining training data for training a machine learning model, wherein the training data comprises features characterizing a request that was completed by at least one agent and a time it took the at least one agent to complete the request and wherein the machine learning model is configured to generate as output an estimated time that it will take an agent to complete a new request;
training the machine learning model on the training data to generate a trained machine learning model;
receiving features of a new request; and
processing the features of the new request using the trained machine learning model to generate as output an estimate of an amount of time that it will take an agent to complete the new request.

2. The method of claim 1, wherein training the machine learning model comprises:
receiving for each of a plurality of requests a measure of successful completion; and
training the machine learning model on training data that includes only requests completed with a measure of successful completion that is greater than a threshold value.

3. The method of claim 2, wherein the method further comprises allocating resources to complete the new request based on the estimate of the amount of time that it will take an agent to complete the new request.

4. A computer-implemented method comprising:
receiving a request;
determining a category of the request;
determining actions associated with completing the request;
using a machine learning model to estimate an amount of time to complete the request based on the category and the actions associated with completing the request, wherein the machine learning model was trained using features characterizing a previous request that was completed by at least one agent and a time it took the at least one agent to complete the previous request; and
rating an agent's performance based in part on a comparison of an amount of time it takes an agent to complete the request and the estimate of the amount of time for an agent to complete the request generated by the machine learning model.

5. The method of claim 4 wherein determining a category comprises:
receiving text corresponding to the request;
identifying one or more keywords of the text; and
determining the category of the request based, at least in part, on the one or more keywords.

6. The method of claim 4 wherein determining actions associated with completing the request comprises:
receiving text corresponding to the request;
identifying one or more keywords of the text; and
determining the actions associated with completing the request based, at least in part, on the one or more keywords.

7. The method of claim 4 further comprising obtaining a tag for the request from preferences of a user, wherein the preferences of the user are determined from actions associated with completing one or more previous requests.

8. The method of claim 7 wherein the machine learning model estimates the time to complete the request based at least in part on a request category, the actions associated with completing the request, and a request tag.

9. The method of claim 4 wherein the request that is completed by the at least one agent is assigned to the at least one agent based at least in part on features characterizing the request.

10. A computer implemented method comprising:
receiving a request;
obtaining a first tag for the request;
receiving, from an agent, a second tag for the request; and
using a machine learning model to estimate a time to complete the request based on the first tag and the second tag, wherein the machine learning model was trained using features characterizing a previous request that was completed by at least one agent and the time it took the at least one agent to complete the previous request.

11. The method of claim 10, wherein determining a category comprises:
receiving text corresponding to the request;
identifying one or more keywords of the text; and
determining the category of the request based, at least in part, on the one or more keywords.

12. The method of claim 10 wherein determining actions associated with completing the request comprises:
receiving text corresponding to the request;
identifying one or more keywords of the text; and
determining the actions associated with completing the request based, at least in part, on the one or more keywords.

13. The method of claim 10 further comprising obtaining a tag for the request from preferences of a user, wherein the preferences of the user are determined from actions associated with completing one or more previous requests.

14. The method of claim 10 wherein the machine learning model estimates the time to complete the request based at least in part on a request category, the actions associated with completing the request, and a request tag.

15. A system comprising:
one or more computers and one or more storage devices on which are stored instructions that are operable, when executed by the one or more computers, to cause the one or more computers to perform operations comprising:
receiving a request;
determining a category of the request;
determining actions associated with completing the request;
using a machine learning model to estimate an amount of time to complete the request based on the category and the actions associated with completing the request, wherein the machine learning model was trained using features characterizing a previous request that was completed by at least one agent and a time it took the at least one agent to complete the previous request; and
rating an agent's performance based in part on a comparison of the amount of time it takes an agent to complete the request and the estimated amount of time to complete the request generated by the machine learning model.

16. The system of claim 15 wherein obtaining a category comprises:
receiving text corresponding to the request;
identifying one or more keywords of the text; and
determining the category of the request based, at least in part, on the one or more keywords.

17. The system of claim 15 wherein obtaining actions associated with completing the request comprises:
receiving text corresponding to the request;
identifying one or more keywords of the text; and
determining the actions associated with completing the request based, at least in part, on the one or more keywords.

18. The system of claim 15, wherein the operations further comprise obtaining a tag for the request from a profile of preferences of a user, wherein the preferences of the user is determined from actions associated with completing one or more previous requests.

19. The system of claim 18 wherein the machine learning model estimates the time to complete the request based on the category, the actions associated with completing the request, and the tag.

20. The system of claim 15 wherein the request that is completed by the at least one agent is assigned to the at least one agent based at least in part on features characterizing the request.
